(19) United States
(12) Patent Application Publication
(10) Pub. No.: US 2012/0100517 A1
(43) Pub. Date: Apr. 26, 2012

(54) Real-time, interactive, three-dimensional virtual surgery system and method thereof

(76) Inventors: Andrew Bowditch, Wayland, MA (US); Matthew Bowditch, Wellesley, MA (US)

(21) Appl. No.: 13/200,729

(22) Filed: Sep. 29, 2011

Related U.S. Application Data
(60) Provisional application No. 61/404,285, filed on Sep. 30, 2010.

(51) Int. Cl. G09B 23/30

(52) U.S. Cl. 434/267

(57) ABSTRACT

A real-time, interactive, three-dimensional (3D) virtual surgical system including a 3D scene having a timeline and a plurality of artist-rendered 3D objects each representing a human anatomical structure and a plurality of 3D objects each representing a medical device or a medical instrument. Each object includes a number of definable properties each associated with a location on the timeline. A timeline controller generates camera controller commands, generates and sends time commands to select locations on the timeline, and generates and sends play or pause commands to the 3D scene. A camera controller generates camera position commands for any camera position. A camera is responsive to the camera position commands and is configured to read the 3D scene and generate and send views to an output device to create a real-time, interactive, 3D virtual surgical procedure having views for any camera position.

### RELATED APPLICATIONS

This application hereby claims the benefit of and priority to U.S. Provisional Application Ser. No. 61/404,285, filed on Sep. 30, 2010 under 35 U.S.C. §§119, 120, 363, 365, and 37 C.F.R. §1.55 and §1.78, incorporated by reference herein.

### FIELD OF THE INVENTION

This invention relates to a real-time, interactive, three-dimensional (3D) virtual surgery system and method thereof.

### BACKGROUND OF THE INVENTION

Conventional methods and systems for training surgeons, doctors, residents, interns, students, and the like, for surgical procedures may include, inter alia, textbooks, videos of actual surgical procedures, and computerized surgical training systems.

Manufactures of medical devices and implants, such as artificial hip replacements, knee replacements, spinal implants, stents, and the like, need to have their medical devices approved by the Food and Drug Administration (FDA). Once the device is approved by the FDA, the manufactures often need to train surgeons of the proper surgical techniques associated with the medical device.

Conventional computerized virtual surgical training systems often rely on fixed images obtained from X-rays, MRIs, CTs and the like to create a virtual surgical procedure. Other conventional computerized virtual surgical training systems may rely on generating virtual radiographic images of portions of a virtual patient.

The images of conventional computerized virtual surgical training systems may not depict an accurate depiction of the normal human anatomical structures, the medical instruments and/or the medical devices or implants associated with a virtual surgical procedure. Conventional computerized virtual surgical training systems may provide limited camera views of the virtual surgical procedure, may not be able to select and identify human anatomical structures, medical instruments and/or medical devices associated with the virtual surgery, and may not adjust the opacity level of human anatomical structures, medical instruments and/or the devices. The result may be ineffective and inaccurate surgical training.

### SUMMARY OF INVENTION

In one aspect, a real-time, interactive, three-dimensional (3D) virtual surgical system is featured including a 3D scene. The 3D scene includes a timeline and a plurality of artist-rendered 3D objects each representing a human anatomical structure and a plurality of 3D objects each representing a medical device or a medical instrument, each object having a number of definable properties each associated with a location on the timeline. A timeline controller is configured to input a timeline file and/or user timeline input. The timeline controller is further configured to generate camera controller commands, generate and send time commands to select locations on the timeline, and generate and send play or pause commands to the 3D scene. A camera controller is responsive to the camera controller commands and/or user camera position input. The camera controller is configured to generate camera position commands for any camera position. A camera is responsive to the camera position commands and is configured to read the 3D scene and generate and send views to an output device to create a real-time, interactive, 3D virtual surgical procedure including views for any camera position.

In one embodiment, the timeline controller may be further configured to generate opacity level data. The system may include an opacity controller responsive to the opacity level data and/or user opacity input. The opacity controller may be configured to generate and send opacity level commands to the 3D scene to define the opacity level of one or more of the 3D objects to create the real-time, 3D, virtual surgical procedure having one or more 3D objects with different opacity levels. The timeline controller may be further configured to generate selection/identification data. The system may include a selection/identification controller responsive to the selection/identification data and/or user selection/identification input. The selection/identification controller may be configured to generate and send selection/identification commands to the 3D scene to define selection/identification of one or more of the 3D objects to create the real-time, 3D, virtual surgical procedure having selection and identification of one or more 3D objects. The definable properties of each object associated with the timeline may include one or more of: a 3D shape, a position in 3D space, an opacity level, and/or selection/identification status. The timeline controller may be further configured to generate audio playback commands. The system may include an audio controller responsive to the audio playback commands configured to input an audio file including a voice-over surgical explanation of the virtual surgical procedure and integrate the audio file with the virtual surgical procedure. The timeline controller may be configured to generate on-screen text display commands. The system may include an on-screen text controller responsive to the on-screen text display commands configured to input a text file including on-screen text explaining the virtual surgical procedure and configured to integrate the on-screen text with the virtual surgical procedure. The timeline controller may be further configured to generate video playback commands. The system may include a video controller responsive to the video playback commands configured to input a video file including a video of an actual surgical procedure and display the video adjacent to and synchronized with the real-time, interactive, 3D virtual surgical procedure. The video may include audio associated with the actual surgical procedure. The output device may include an electronic display device. The system may be configured as an application to run on an electronic device accepting input and producing output.

In another aspect, a real-time, interactive, three-dimensional (3D) virtual surgical system is featured including a 3D scene. The 3D scene includes a timeline and a plurality of artist-rendered 3D objects each representing a human anatomical structure and a plurality of 3D objects each representing a medical device, or a medical instrument, each object having a number of definable properties each associated with a location on the timeline. A timeline controller is configured to input a timeline file and/or user timeline input. The timeline controller is configured to generate opacity level data, generate and send time commands to select locations on the timeline and generate and send play or pause commands to the 3D scene. An opacity controller is responsive to the opacity level data and/or user opacity input. The opacity controller is configured to generate opacity commands to define the opacity level of one or more of the 3D objects. A camera is configured to read the 3D scene and generate and send views to an output device to create a real-time, interactive, 3D virtual surgical procedure having one or more 3D objects with different opacity levels.

In one embodiment, the timeline controller may be configured to generate camera controller commands for any camera view and the camera may be responsive to the camera position commands to create the real-time, interactive, 3D virtual surgical procedure having views for any camera position. The timeline controller may be configured to generate selection/identification data. The system may include a selection/identification controller responsive to the selection/identification data and/or user selection/identification input. The selection/identification controller may be configured to generate and send selection/identification commands to the 3D scene to define selection/identification of one or more of the 3D objects to create the real-time, interactive, 3D virtual surgical procedure having selection and identification of one or more of 3D objects. The definable properties of each object associated with the timeline may include one or more of: a 3D shape, a position and 3D space, and opacity level, and/or selection/identification status. The timeline controller may be configured to generate audio playback commands. The system may include an audio controller responsive to the audio playback commands configured to input an audio file including a voice-over surgical explanation of the virtual surgical procedure and integrate the audio file with the virtual surgical procedure. The timeline controller may be configured to generate on-screen text display commands. The system may include an on-screen text controller responsive to the on-screen text display commands configured to input a text file including on screen text explaining the virtual surgical procedure and configured to integrate the on-screen text with the virtual surgical procedure. The timeline may be further configured to generate video playback commands. The system may include a video controller responsive to the video playback commands configured to input a video file including a video of an actual surgical procedure and display the video adjacent to and synchronized with the real-time, interactive, 3D virtual surgical procedure. The video may include audio associated with the actual surgical procedure. The output device may include an electronic display device. The system may be configured as an application to run on an electronic device accepting input and producing output.

In yet another aspect, a real-time, interactive, three-dimensional (3D) virtual surgical system is featured including a 3D scene. The 3D scene includes a timeline and a plurality of artist-rendered 3D objects each representing a human anatomical structure and a plurality of 3D objects each representing a medical device or a medical instrument, each object having a number of definable properties each associated with a location on the timeline. A timeline controller is configured to input a timeline file and/or user timeline input. The timeline controller is further configured to generate selection/identification data, generate and send time commands to select locations on the timeline, and generate and send play or pause commands to the 3D scene. A selection/identification controller is responsive to the selection/identification data and/or user selection/identification input. The selection/identification controller is configured to generate and send selection/identification commands to the 3D scene to define selection/identification of one or more of the 3D objects. A camera is configured to read the 3D scene and generate and send views to an output device to create a real-time, interactive, 3D virtual surgical procedure having selection and identification of one of more of 3D objects.

In one embodiment, the timeline controller may be configured to generate camera controller commands for any camera view and the camera may be responsive to the camera position commands to create the real-time, interactive, 3D virtual surgical procedure having views for any camera position. The timeline controller may be configured to generate opacity level data. The system may include an opacity controller responsive to the opacity level data and/or user opacity input. The opacity controller is configured to generate and send opacity level commands to the 3D scene to define the opacity level of one or more of the 3D objects to create the real-time, 3D, virtual surgical procedure having one or more 3D objects with different opacity levels. The definable properties of each object associated with the timeline may include one or more of: a 3D shape, a position and 3D space, and opacity level, and/or selection/identification status. The timeline controller may be configured to generate audio playback commands. The system may include an audio controller responsive to the audio playback commands configured to input an audio file including a voice-over surgical explanation of the virtual surgical procedure and integrate the audio file with the virtual surgical procedure. The timeline controller may be configured to generate on-screen text display commands. The system may include an on-screen text controller responsive to the on-screen text display commands configured to input a text file including on screen text explaining the virtual surgical procedure and configured to integrate the on-screen text with the virtual surgical procedure. The timeline controller may be further configured to generate video playback commands. The system may include a video controller responsive to the video playback commands configured to input a video file including a video of an actual surgical procedure and display the video adjacent to and synchronized with the real-time, interactive, 3D virtual surgical procedure. The video may include audio associated with the actual surgical procedure. The output device may include an electronic display device. The system may be configured as an application to run on an electronic device accepting input and producing output.

In another aspect, a real-time, interactive, three-dimensional (3D) virtual surgical system is featured including a 3D scene. The 3D scene includes a timeline and a plurality of artist-rendered 3D objects each representing a human anatomical structure and a plurality of 3D objects each representing a medical device or a medical instrument, each object having a number of definable properties each associated with a location on the timeline. A timeline controller is configured to input a timeline file and/or user timeline input. The timeline controller is further configured to generate camera controller commands, generate opacity level data, generate selection/identification data, generate and send time commands to select locations on the timeline, and generate and send play or pause commands to the 3D scene. An opacity controller is responsive to the opacity level data and/or user opacity input. The opacity controller is configured to generate opacity commands to define the opacity level of one or more of the 3D objects. A selection/identification controller is responsive to the selection/identification data and/or the user selection/identification input. The selection/identification controller is configured to generate and send selection/identification commands to the 3D scene to define selection/identification of one or more of the 3D objects. A camera controller is responsive to the camera controller commands and/or user camera position input. The camera controller is configured to generate camera position commands for any camera position. A camera is responsive to the camera position commands and is configured to read the 3D scene and generate and send views to an output device to create a real-time, interactive, 3D virtual surgical procedure having views for any camera position, one or more 3D objects with different opacity levels, and selection and identification of one or more of 3D objects.

In one embodiment, the timeline may be further configured to generate video playback commands. The system may include a video controller responsive to the video playback commands configured to input a video file including a video of an actual surgical procedure and display the video adjacent to and synchronized with the real-time, interactive, 3D virtual surgical procedure. The video may include audio associated with the actual surgical procedure.

In another aspect, a method for providing a real-time, interactive, three-dimensional (3D) virtual surgical system is featured, the method including providing a 3D scene including a timeline and a plurality of artist-rendered 3D objects each representing a human anatomical structure and a plurality of 3D objects each representing a medical device or a medical instrument, each object having a number of definable properties each associated with a location on the timeline, generating and sending timeline commands to select locations on the timeline, generating and sending play or pause commands to the 3D scene, generating camera positions for any camera position, and generating and sending views to an output device to create a real-time, interactive, three-dimensional virtual surgical procedure having views for any camera position.

In one embodiment, the method may include the step of generating opacity level commands and sending the opacity level commands to the 3D scene to define the opacity level of one or more of the 3D objects to create the real-time, 3D, virtual surgical procedure having one or more 3D objects with different opacity levels. The method may include the step of generating selection/identification commands and sending the selection/identification commands to the 3D scene to define selection/identification of one or more of the 3D objects to create the real-time, 3D, virtual surgical procedure having selection and identification of one or more 3D objects. The method may include the step of generating video playback commands. The method may further include the step of inputting a video file including a video of an actual surgical procedure and displaying the video adjacent to and synchronized with the real-time, interactive, three-dimensional virtual surgical procedure. The video may include audio associated with the actual surgical procedure.

In yet another aspect, a method for providing a real-time, interactive, three-dimensional (3D) virtual surgical system is featured, the method including generating a 3D scene including a timeline and a plurality of artist-rendered 3D objects each representing a human anatomical structure and a plurality of 3D objects each representing a medical device or a medical instrument, each 3D object having a number of definable properties associated with a location on the timeline, generating and sending timeline commands to select locations on the timeline, generating and sending play or pause commands to the 3D scene, generating opacity level commands to define the opacity levels of one or more of the 3D objects, and generating and sending views to an output device to create a real-time, interactive, three-dimensional virtual surgical procedure having one or more 3D objects with different opacity levels.

In one embodiment, the method may include the step of generating camera position commands for any camera position to create the real-time, 3D, virtual surgical procedure having views for any camera position. The method may include the step of generating selection/identification commands and sending the selection/identification commands to the 3D scene to define selection/identification of one or more of the 3D objects to create the real-time, 3D, virtual surgical procedure having selection and identification of one or more 3D objects. The method may include the step of generating video playback commands. The method may further include the step of inputting a video file including a video of an actual surgical procedure and displaying the video adjacent to and synchronized with the real-time, interactive, three-dimensional virtual surgical procedure. The video may include audio associated with the actual surgical procedure.

In yet another aspect, a method for providing a real-time, interactive, three-dimensional (3D) virtual surgical system is featured, the method including providing a 3D scene including a timeline and a plurality of artist-rendered 3D objects each representing a human anatomical structure and a plurality of 3D objects each representing medical device or medical instrument, each object having a number of definable properties each associated with a location on the timeline, generating and sending timeline commands to select locations on the timeline, generating and sending play or pause commands to the 3D scene, generating selection/identification commands and sending the selection/identification commands to the 3D scene to define selection/identification of one or more of the 3D objects, generating and sending views to an output device to create a real-time, interactive, three-dimensional virtual surgical procedure having selection and identification of one or more 3D objects.

In one embodiment, the method may include the step of generating camera position commands for any camera position to create the real-time, 3D, virtual surgical procedure for any camera position. The method may include the step of generating opacity level commands and sending the opacity level commands to the 3D scene to define the opacity level of one or more of the 3D objects to create the real-time, 3D, virtual surgical procedure having one or more 3D objects with different opacity levels. The method may include the step of generating video playback commands. The method may further include the step of inputting a video file including a video of an actual surgical procedure and displaying the video adjacent to and synchronized with the real-time, interactive, three-dimensional virtual surgical procedure. The video may include audio associated with the actual surgical procedure.

In yet another aspect, a method for providing a real-time, interactive, three-dimensional (3D) virtual surgical system is featured, the method including providing a 3D scene including a timeline and a plurality of artist-rendered 3D objects each representing a human anatomical structure and a plurality of 3D objects each representing medical device or medical instrument, each object having a number of definable properties each associated with a location on the timeline, generating and sending timeline commands to select locations on the timeline, generating camera positions for any camera position, generating opacity level commands to define the opacity levels of one or more of the 3D objects, generating selection/identification commands and sending the selection/identification commands to the 3D scene to define selection/identification of one or more of the 3D objects, generating and sending play or pause commands to the 3D scene, and generating and sending views to an output device to create a real-time, interactive, three-dimensional virtual surgical procedure having views for any camera position, one or more 3D objects with different opacity levels, and selection and identification of one or more 3D objects.

In one embodiment, the method may include the step of generating video playback commands. The method may further include the step of inputting a video file including a video of an actual surgical procedure and displaying the video adjacent to and synchronized with the real-time, interactive, three-dimensional virtual surgical procedure. The video may include audio associated with the actual surgical procedure.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing the primary components of one embodiment of the real-time, interactive, three-dimensional virtual surgery system of this invention;

FIG. 2 is a flowchart showing one example of the primary steps used to create the 3D scene shown in FIG. 1;

FIG. 3 is a three-dimensional view showing one example of artist-rendered 3D objects of human anatomical structures which may be part of the virtual surgical procedure in FIG. 1;

FIG. 4 is a three-dimensional view of another example of artist-rendered 3D objects of human anatomical structures which may be part of the virtual surgical procedure shown in FIG. 1;

FIG. 5 is a three-dimensional view of one example of 3D objects representing medical instruments which may be part of the virtual surgical procedure scene shown in FIG. 1;

FIG. 6 is a three-dimensional view of one example of a 3D object representing a medical device which may be part of the virtual surgical procedure scene shown in FIG. 1;

FIGS. 7-12 are three-dimensional views depicting one embodiment of the virtual surgical system of this invention showing a number of exemplary camera views of one step of the real-time, interactive, 3D virtual surgical procedure;

FIGS. 13-15 are three-dimensional views depicting one embodiment of the virtual surgical system of this invention wherein the opacity level of a 3D object representing human anatomical structure has been changed;

FIGS. 16-17 are three-dimensional views depicting one embodiment of the virtual surgical system of this invention wherein the opacity level of a 3D object representing a medical instrument has been changed;

FIGS. 18-20 are three-dimensional views depicting one embodiment of the virtual surgical system of this invention wherein the opacity level of a 3D object representing a medical device has been changed;

FIG. 21 is a three-dimensional view depicting one embodiment of the virtual surgical system of this invention wherein the selection and identification of a 3D object representing a human anatomical structure has been performed;

FIG. 22 is a three-dimensional view depicting one embodiment of the virtual surgical system of this invention wherein of the selection and identification of a 3D object representing a medical instrument has been performed;

FIG. 23 is a three-dimensional view depicting one embodiment of the virtual surgical system of this invention wherein the selection and identification of a 3D object representing a medical device has been performed;

FIGS. 24-25 are three-dimensional views depicting one embodiment of the virtual surgical system of this invention with on-screen text displayed with the virtual surgical procedure;

FIG. 26 is three-dimensional views showing one example of a change in the 3D shape of an artist-rendered 3D object in accordance with one embodiment this invention;

FIG. 27 is a block diagram showing the primary components of another embodiment of the real-time, interactive, three-dimensional virtual surgery system of this invention wherein an actual surgical video is displayed adjacent to the real-time, interactive, 3D virtual surgical procedure 94 shown in one or more of FIGS. 1-26; and

FIG. 28 is a three-dimensional view of one embodiment of the real-time, non-interactive, three-dimensional virtual surgery system synchronized with a real surgical video in accordance with this invention

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

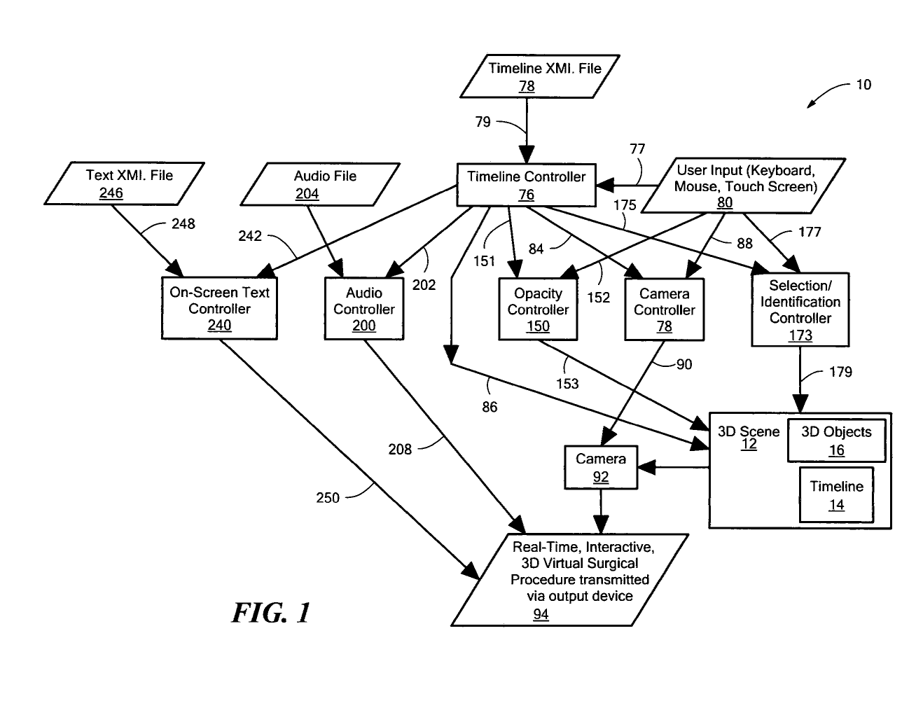

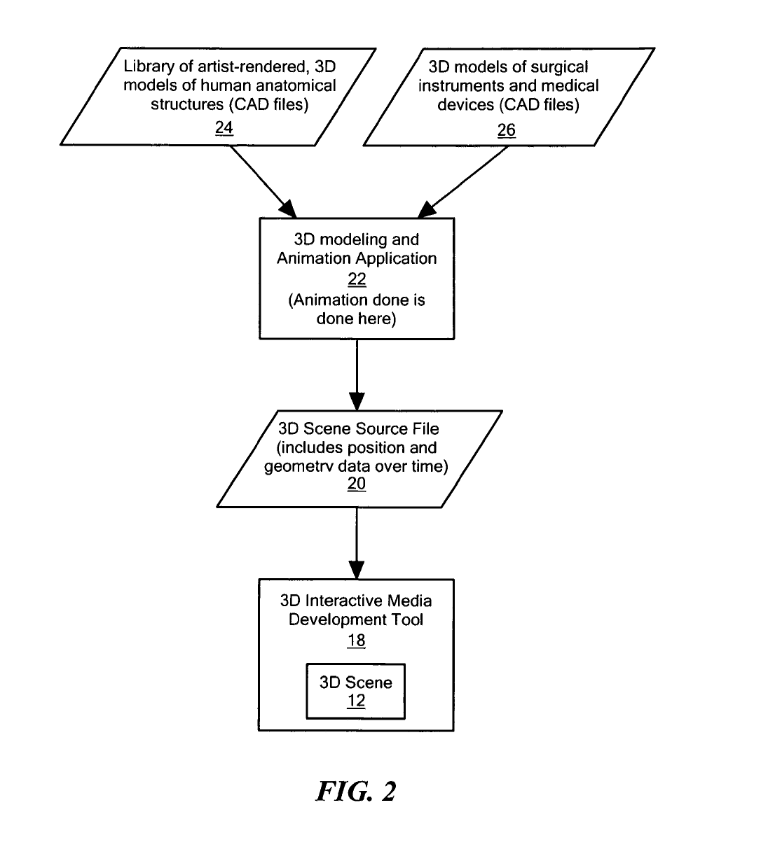

There is shown in FIG. 1, one embodiment of real-time, interactive, 3D virtual surgical system 10 of this invention. System 10 includes 3D scene 12 which includes timeline 14 and a plurality of 3D objects 16. Some of the objects in 3D objects 16 may be artist-rendered and represent a human anatomical structure. Other objects in 3D objects 16 may represent a medical device or a medical instrument and need not necessarily be artist-rendered, although they could be, if desired. 3D scene 12 with 3D objects 16 is typically created by 3D interactive media development tool 18, FIG. 2, e.g., Unity® or similar type 3D interactive media development tool. 3D interactive media development tool 18 typically inputs 3D scene source file 20, e.g., a .fbx or similar type file that includes the position in 3D space of the input 3D objects over time and the 3D shape of the objects over time. 3D scene source file 20 may be created and output by 3D modeling and animation application 22, e.g., 3 ds Max® or similar type animation application. 3D modeling and animation application 22 typically inputs library of artist-rendered 3D models of human anatomical structures 24 and 3D models of medical devices and medical instruments 26 (e.g., CAD files) and creates an animation of a virtual surgical procedure with 3D objects that is output as 3D scene source file 20.

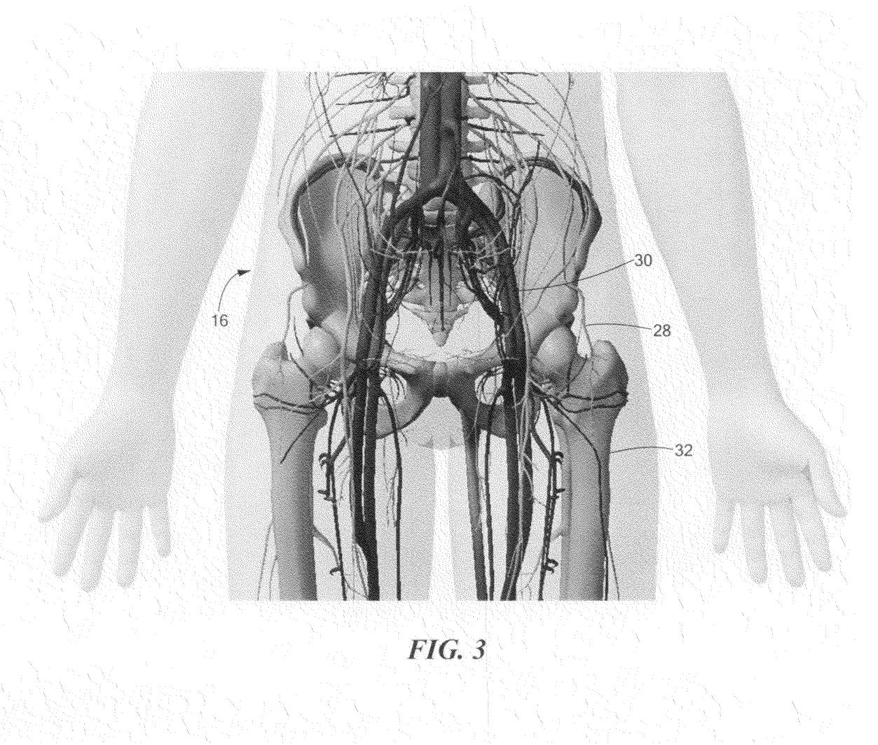

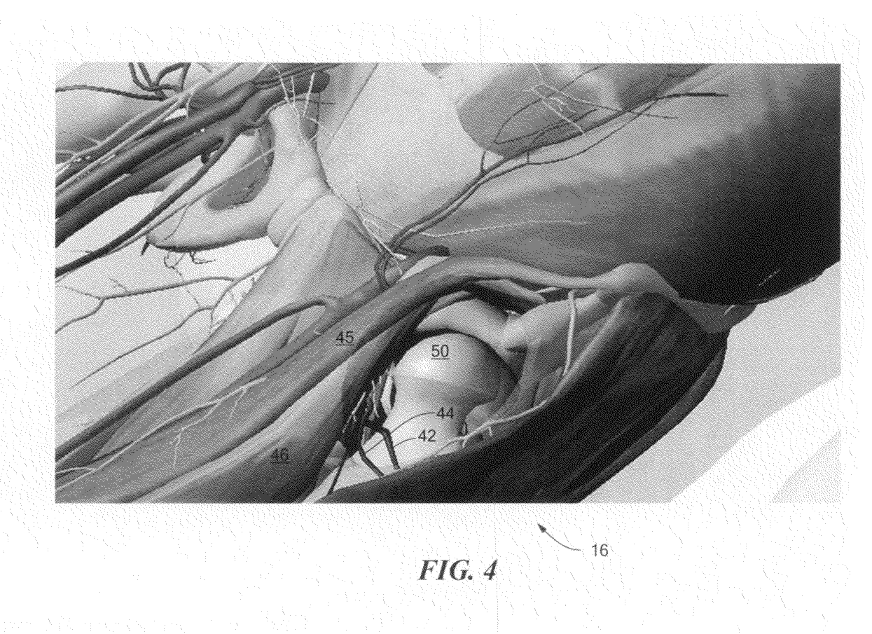

Thus, some of the objects in 3D objects 16, FIG. 1, representing human anatomical structures in 3D scene 12 may be artist-rendered. That is, they are created in 3D by skilled anatomical illustrators using 3D modeling and animation application 22, discussed above with reference to FIG. 2. Because the objects in 3D objects 16 which represent human anatomical structures, FIG. 1, are artist-rendered, they provide a very accurate depiction of normal human anatomical structures. FIG. 3 shows one example of artist-rendered 3D objects 16 of human anatomical structures. Exemplary 3D objects 16 in this example include, inter alia, 3D object 28 of a nerve, 3D object 30 of a vein, and 3D object 32 of the femur. FIG. 4 shows another example of artist-rendered objects 16. In this example, artist-rendered objects 16 include, among others, 3D object 42 of an artery, 3D object 44 of a vein, 3D object 45 of the sartorius, 3D object 46 of the rectus femoris, 3D object 48 of the tensor fascia latae, and 3D object 52 of the femur.

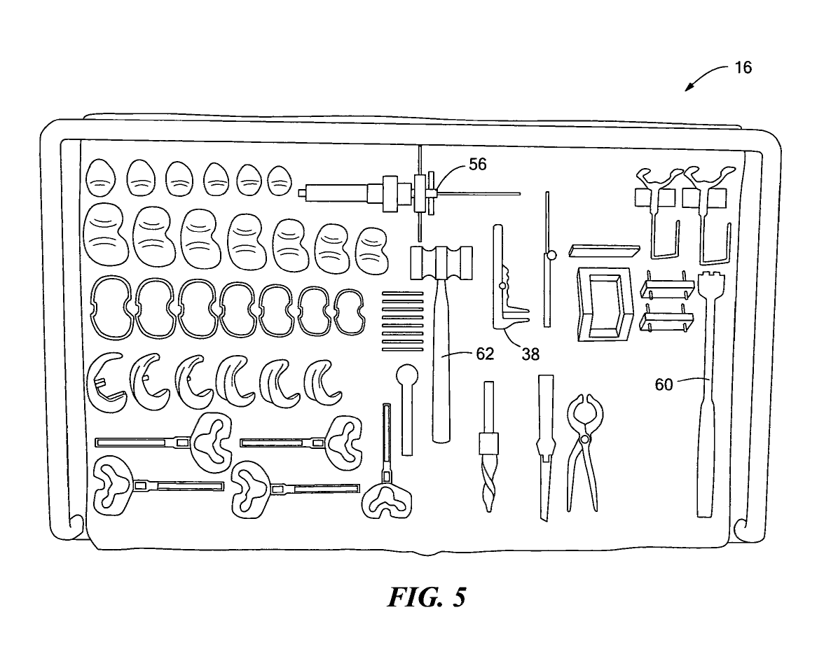

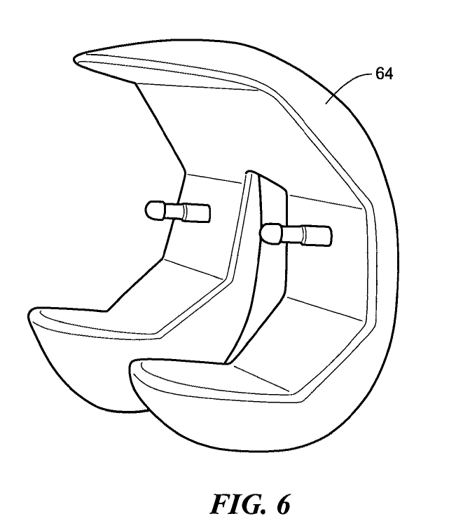

FIG. 5 shows examples of 3D objects 16 representing medical instruments or surgical tools, e.g., surgical tools 56, 58, 60, and 63. FIG. 6 shows an example of 3D object 64 representing a medical device.

As can be seen in FIGS. 3-4, the artist-rendered objects in 3D objects 16 representing human anatomical structures, FIG. 1, in scene 12 may include very detailed and accurate depictions of normal human anatomical structures. The artist-rendered objects in 3D objects 16 shown in FIGS. 3-4 are for illustrative purposes only, as artist-rendered 3D objects 16 may be for any type of human anatomical structure, medical instrument, or medical device known to those skilled in the art.

System 10, FIG. 1, also includes timeline controller 76 which inputs timeline file 78, shown at 79, and/or user timeline input by user input 80, shown at 77. User input 80 may be from a keyboard, a mouse, a touch screen, or similar type input device. Timeline controller 76 generates camera control commands, commands to select locations on timeline 14, and play or pause commands. The camera control commands are sent to camera control 78, as show at 84. The commands to select locations on timeline 14 and the play or pause commands are sent to 3D scene 12, as shown at 86.

Camera controller 78 responds to the camera control commands from timeline controller 76 and/or user camera position input from user input 80, as shown at 84, 88, respectively, and generates camera position commands for any camera position, a full 360° in all planes, and sends the camera position commands to camera 92, as shown at 90. Camera 92 is responsive to the camera position commands and reads 3D scene 12 to generate and sends views to an output device to create a real-time, interactive, 3D virtual surgical procedure 94 that includes views for any camera position. The output device is preferably an electronic display device, such as a computer monitor, a smart-phone display, an electronic tablet display, a computer touch screen display, or any similar type of electronic display which can receive input from an electronic device which can run system 10 and play and display real-time, interactive, 3D virtual surgical procedure 94. Preferably, system 10 is configured as an application to run on the electronic device, e.g., a web application, an executable, on an application for a smart-phone, electronic tablet device, or similar type electronic device.

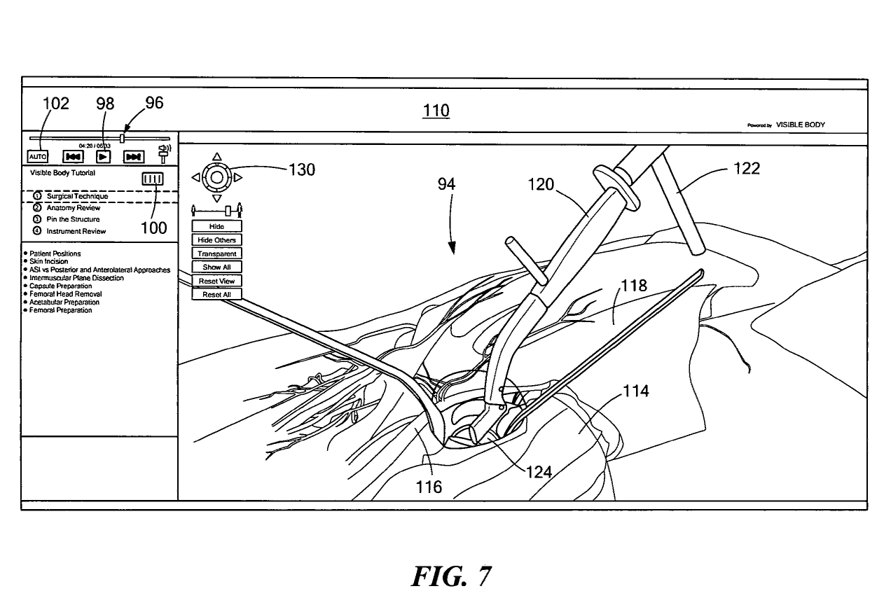

View 110, FIG. 7, depicts one example of the operation of system 10, FIG. 1, wherein real-time, interactive, 3D virtual surgical procedure 94 has been created and is being displayed on an output device. In this example, real-time, interactive, 3D virtual surgical procedure 94, FIG. 7, is for a virtual hip surgical procedure. As shown by slider 96 (discussed in further detail below), virtual surgical procedure 94 has advanced in time to 4 minutes and 20 seconds (4:20) of 8 minute 33 second virtual surgical procedure 94. As can be seen in view 110, virtual surgical procedure 94 created from 3D scene 12, FIG. 1, with 3D objects 16 provides a very detailed and accurate representation of human anatomical structures, medical devices and medical instruments. For example, real-time, interactive, 3D virtual surgical procedure 94, FIG. 7, shows detailed examples of 3D objects representing the tensor fascia latae, indicated at 114, the rectus femoris, indicated at 116, the internal oblique, indicated at 118, an exact offset broach handle medical instrument, indicated at 120, a surgical hammer, indicated at 122, and acetabular cup medical instrument or implant, indicated at 124.

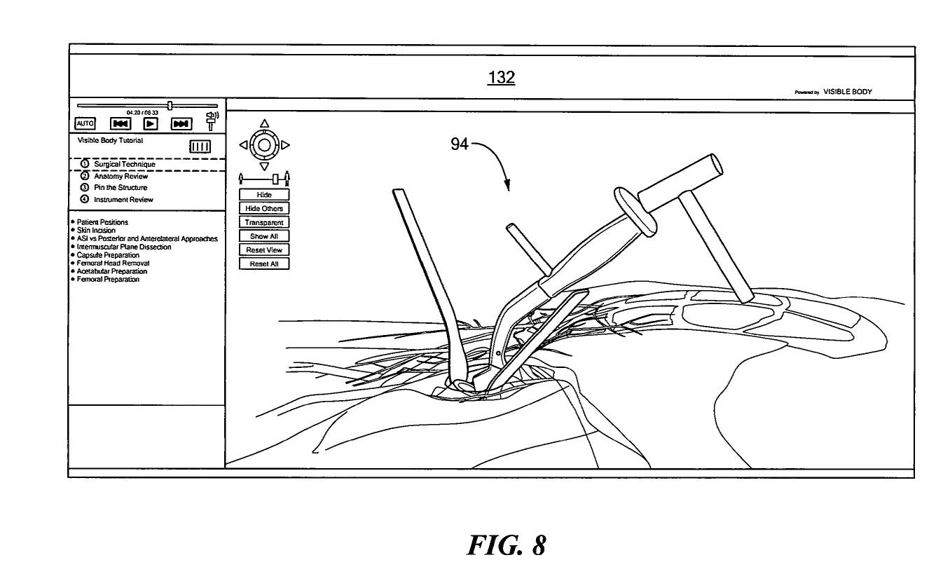

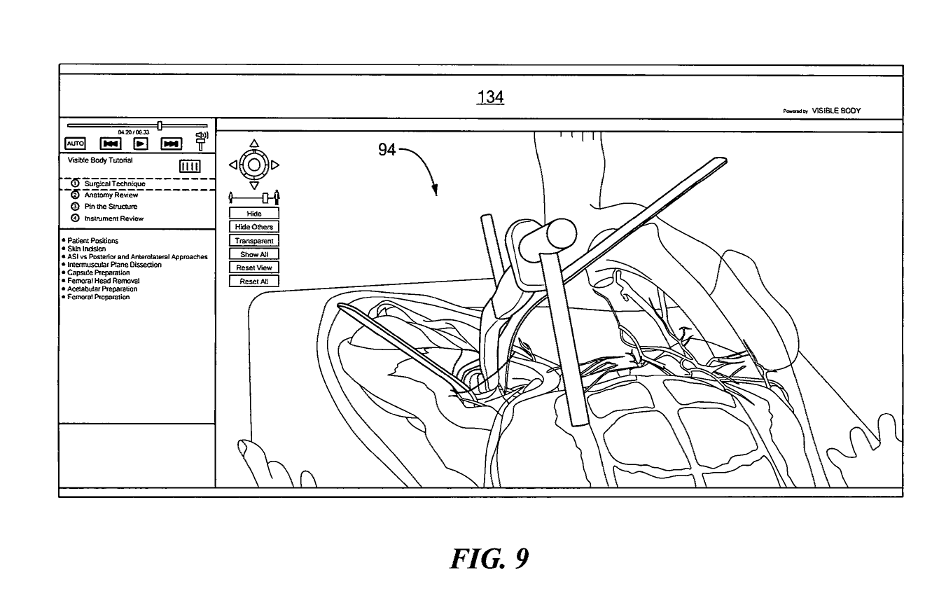

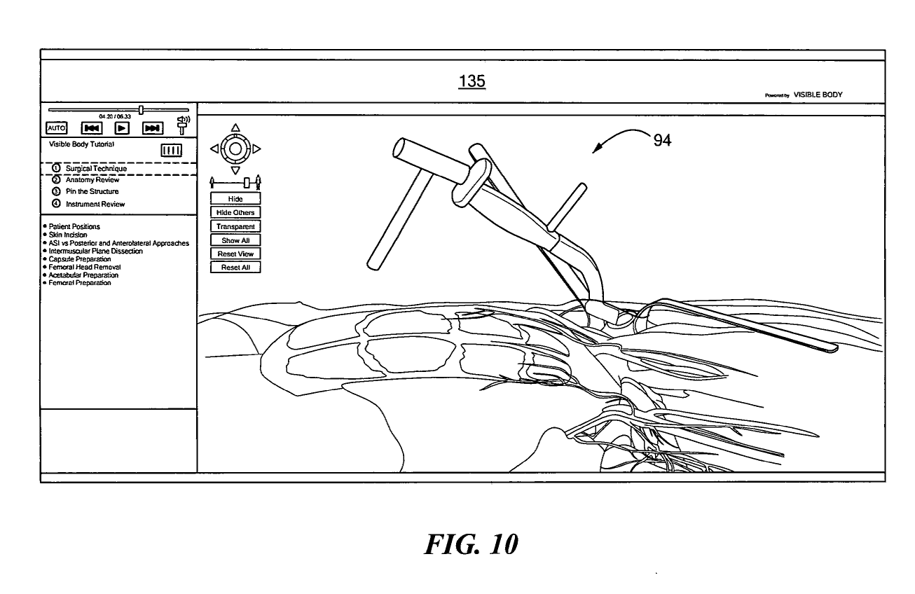

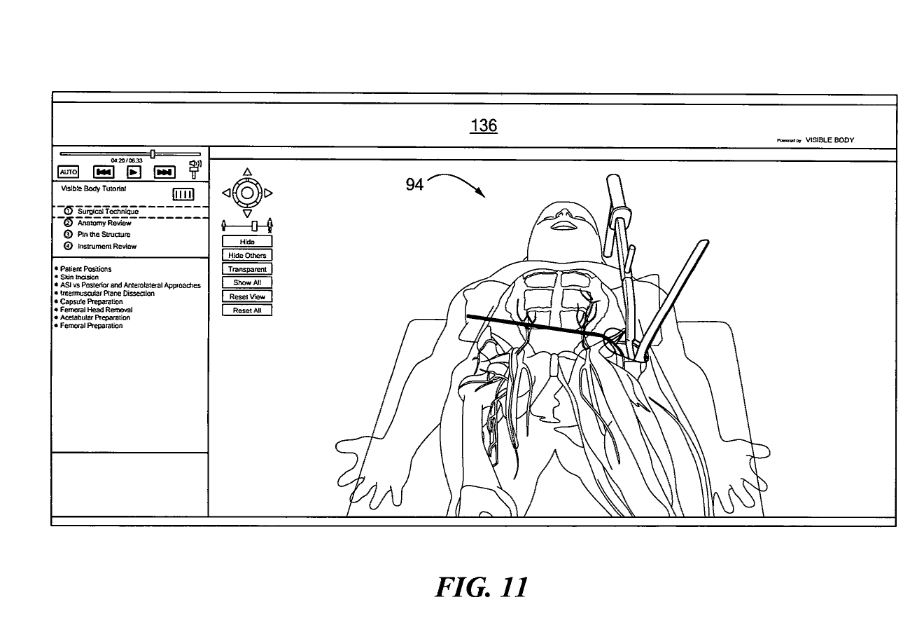

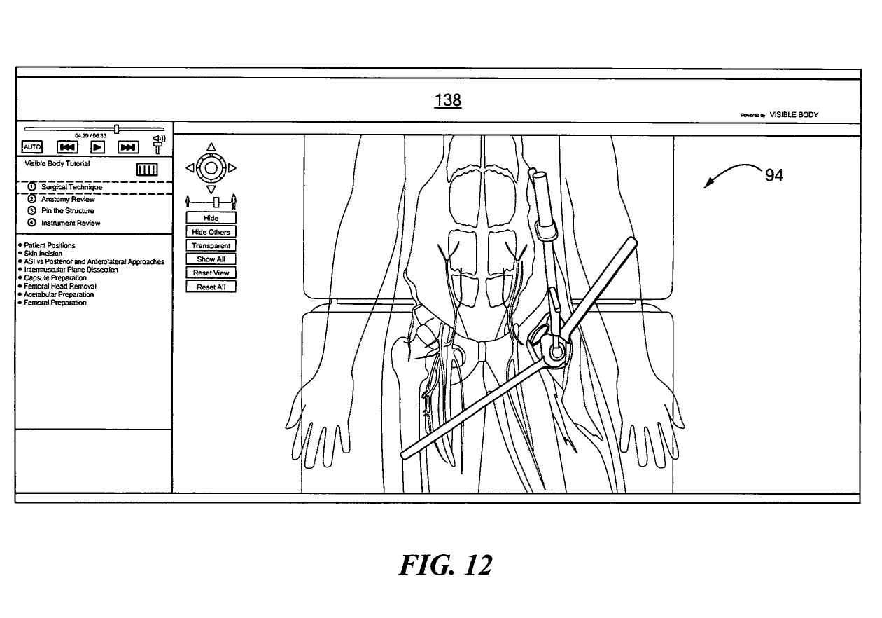

Interactively using view control 130, a mouse, a keyboard, a touch screen, or similar input device, system 10 can rotate the camera view to any view in any plane, a full 360°, to provide a better understanding of virtual surgical procedure 94. FIG. 8 shows an example of view 132 of virtual surgical procedure 94 where the camera view has been rotated slightly to the right. FIG. 9 show an example of view 134 of virtual surgical procedure 94 where the camera view has been rotated further to the right. FIG. 10 shows an example of view 135 of virtual surgical procedure 94 where the camera view has been rotated about 180° from the view in FIG. 7. View 136, FIG. 11, and view 138, FIG. 12 show additional examples of any camera view of virtual surgical procedure 94 which may be created by system 10. Views 110 and 132-138, FIGS. 8-11, are only exemplary views, as system 10 may provide a full 360° of rotation in all planes to provide any view of any step of any virtual surgical procedure as needed by the user.

The result is system 10 provides a real-time, interactive, 3D virtual surgical procedure that includes very accurate depictions of normal human anatomical structures and/or medical devices and/or medical instruments which can be viewed from any camera position. Thus, a surgeon or medical student can learn more about a virtual surgical procedure in relation to the human anatomical structures, medical instruments, and medical devices.

Although as shown in FIGS. 7-11, real-time, interactive, 3D, virtual surgical procedure 94 created by system 10 is shown as a virtual hip surgical procedure, this is not a necessary limitation of this invention, as system 10 can create any type of real-time, interactive, 3D, virtual surgical procedure known to those skilled in the art. A few additional exemplary real-time, interactive, 3D, virtual surgical procedures may include, e.g., knee arthroplasty, spinal implant procedures, stent placement procedures, or similar type surgical procedures.

System 10, FIG. 7, preferably includes interactive slider control 96 which may dragged by a user to any desired location of real-time, interactive, 3D virtual surgical procedure. This allows the user to fast forward or rewind to any desired location in the virtual surgical procedure 94. System 10 also includes play control 98 which causes system 10 to play virtual surgical procedure 94. After play control 98 is pressed, it becomes a stop or pause control, as exemplified by pause control 100. Pause control 100 allows the user to stop the virtual surgical procedure at any point in time. Auto control button 102 turns on the automatic camera movement to provide pre-programmed views. When auto control button 102 is off, the user can control the camera manually. Slider control 96, play control 98, pause control 100 and auto control 102 communicate with user input 80, FIG. 1, which communicates to timeline controller 76. As discussed above, timeline controller 76 sends commands to select locations on timeline 14 and generates and sends play or pause commands to 3D scene 12.

Timeline controller 76, FIG. 1, may be further configured to generate opacity level data and send it to opacity controller 150, as shown at 151. Opacity controller 150 is responsive to the opacity level data and/or user opacity input from user input 80, as shown at 152. Opacity controller 150 generates and sends opacity level commands to 3D scene 12, as shown at 153, to define the opacity level of one or more of 3D objects 16 of 3D scene 14. Camera 92 then reads 3D scene 12 to create real-time interactive, 3D virtual surgical procedure 94 that includes one or more 3D objects having different opacity levels.

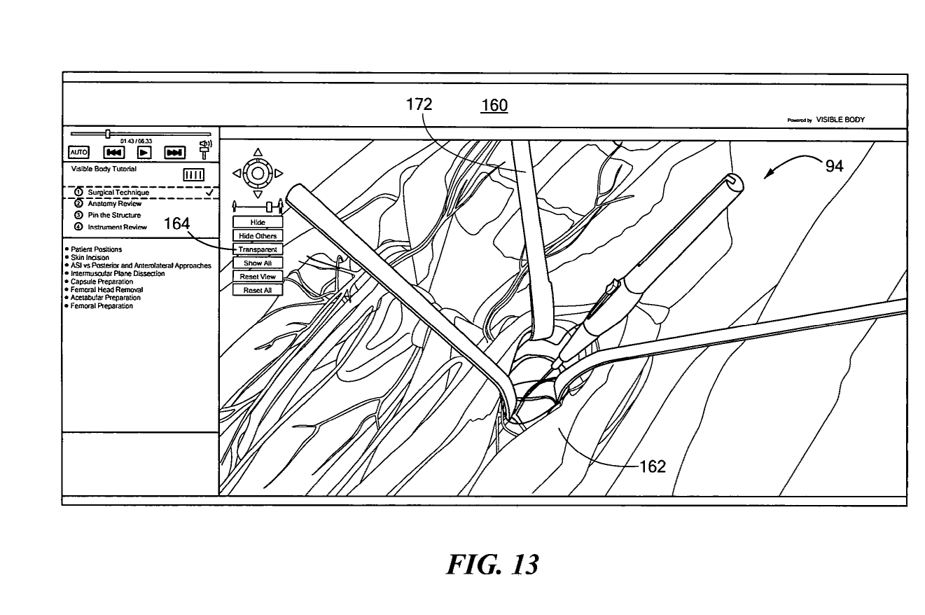

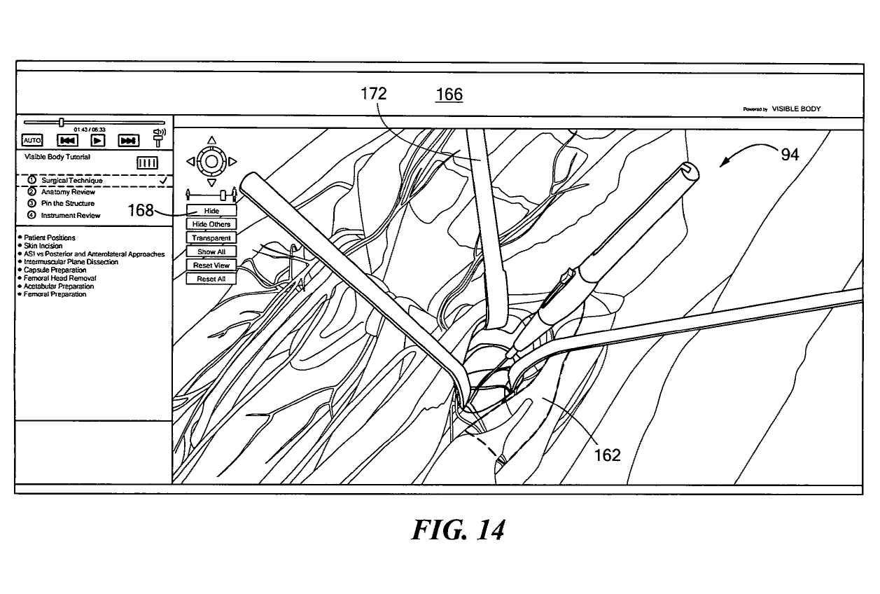

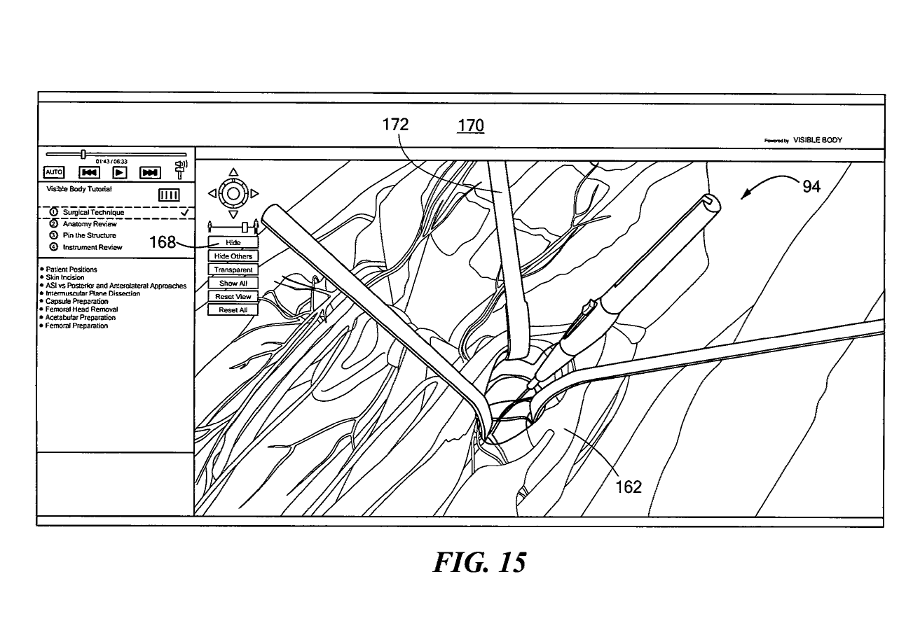

For example, view 160, FIG. 13 shows an example of virtual surgical procedure 94 at 4:43. To change the opacity level of a human anatomical structure 162, in this example the tensor fascia latae, to transparent, the user clicks on structure 162 and then clicks transparent control 164. Opacity controller 150, FIG. 1, responds to the request and generates and sends opacity commands to 3D scene 12. System 10 then changes the opacity of tensor fascia latae 162, FIG. 13, in virtual surgical procedure 94 to transparent as shown in view 166, FIG. 14. To hide tensor fascia latae 162 (set the opacity level to zero), the user clicks hide control 168 and, in a similar manner as discussed above, system 10 hides the tensor fascia latae 162, as shown in view 170, FIG. 15.

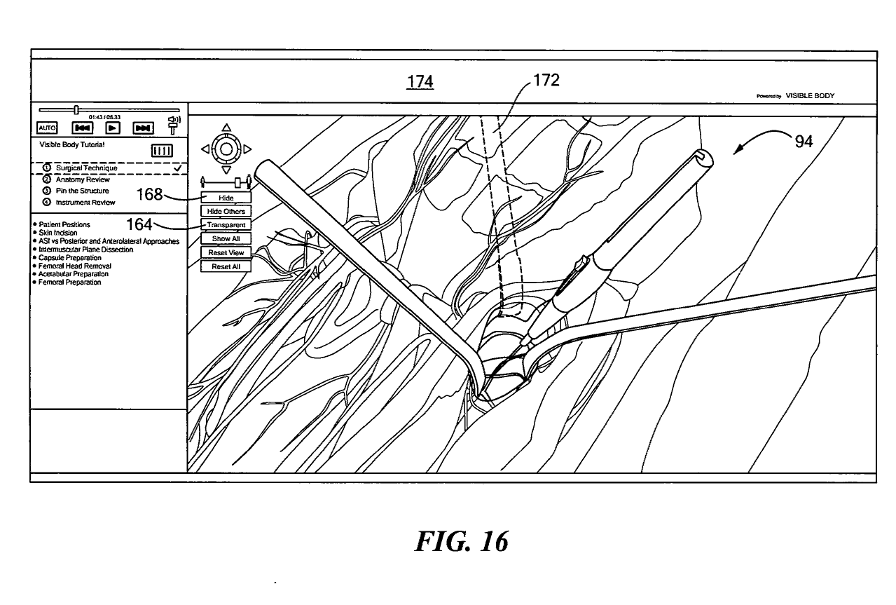

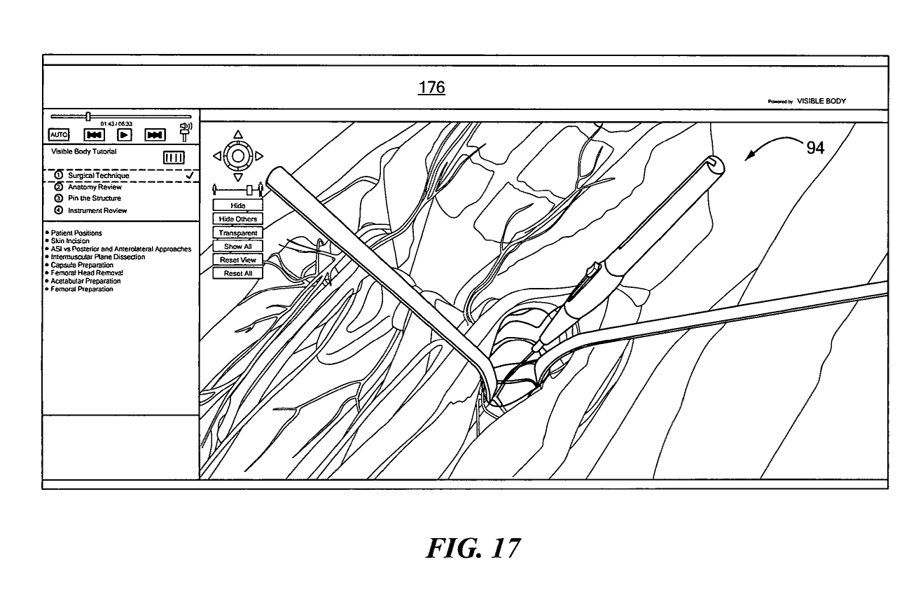

In another example, to change the opacity level of a medical instrument or surgical tool 172, FIG. 13, in this example a large retractor, the user clicks on surgical tool 172 and clicks transparent control 164. In a similar manner as discussed above, system 10 changes the opacity of large retractor 172 to transparent, as shown in view 174, FIG. 16. To hide retractor 172, the user clicks hide control 168 and system 10 hides the large retractor, as shown in view 176, FIG. 17.

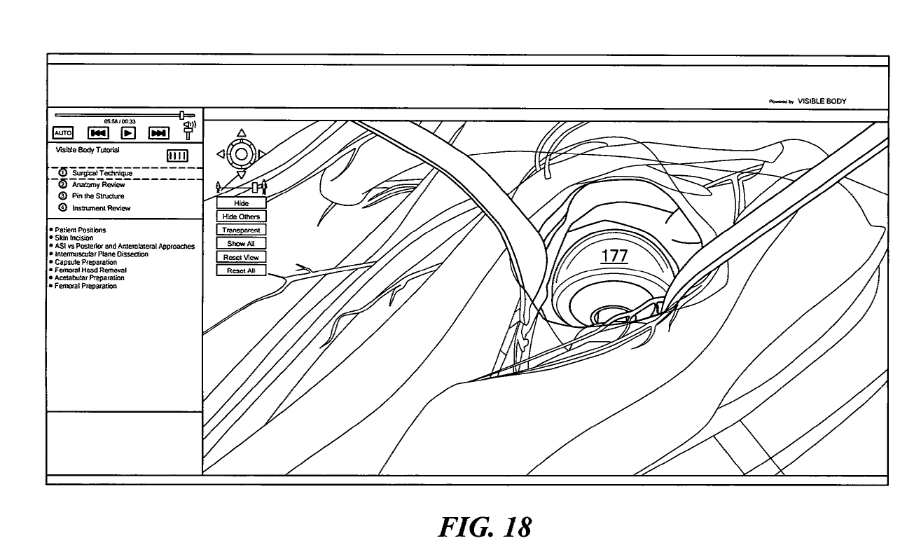

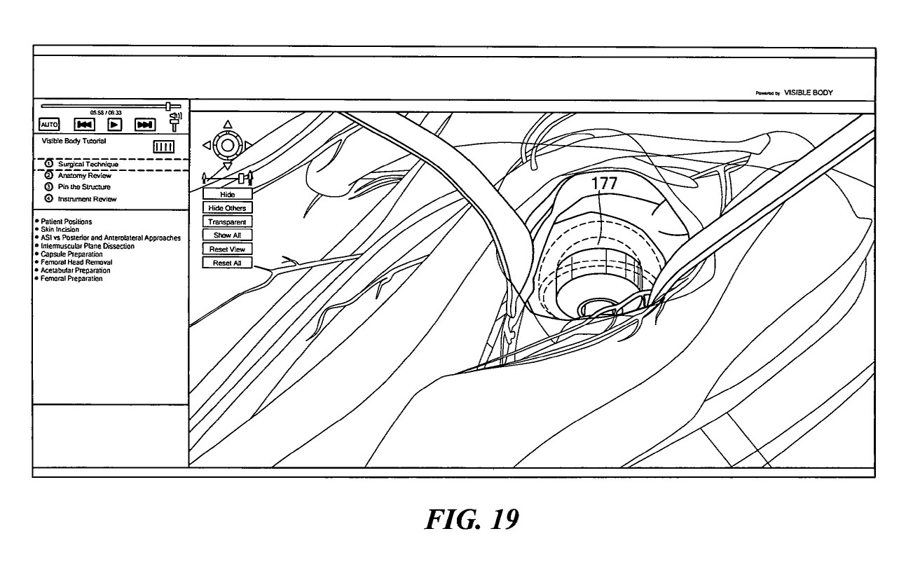

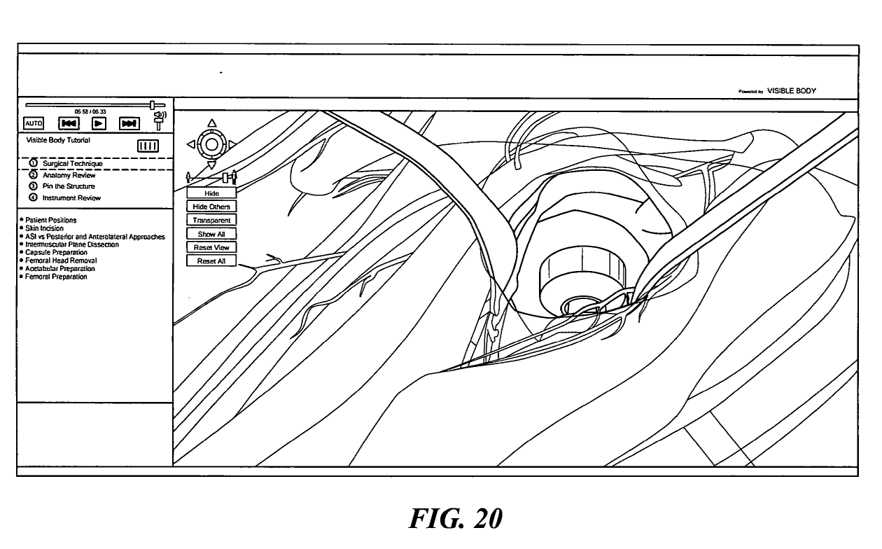

In a similar manner, medical implants and/or medical devices may have their opacity levels changed as shown by medical device 177, FIGS. 18, 19, and 20 being changed from solid, to transparent and then to hidden, respectively.

The result is that system 10 can be used to change the opacity of any 3D objects representing human anatomical structures, medical devices and medical instruments in real-time, interactive, 3D virtual surgical procedure 94 created by system 10 to provide more accurate training of surgical procedures for medical professionals.

System 10, FIG. 1, is preferably configured to select and identify any of the 3D objects representing human anatomical structures, medical devices, or medical instruments in real-time, interactive, 3D virtual surgical procedure 94. In this embodiment, timeline controller 76 is preferably configured to generate selection/identification data and send it to selection/identification controller 173, as shown at 175. Selection/identification controller 173 responds to the selection/identification data and/or user selection/identification input from user input 80, as shown at 177. Selection/identification controller 173 generates and sends selection/identification commands to 3D scene, as shown at 179, to define the selection/identification of one or more of 3D objects 16. Camera 92 then reads 3D scene 12 to create real-time, 3D, virtual surgical procedure 94 having 3D objects that can be selected and identified.

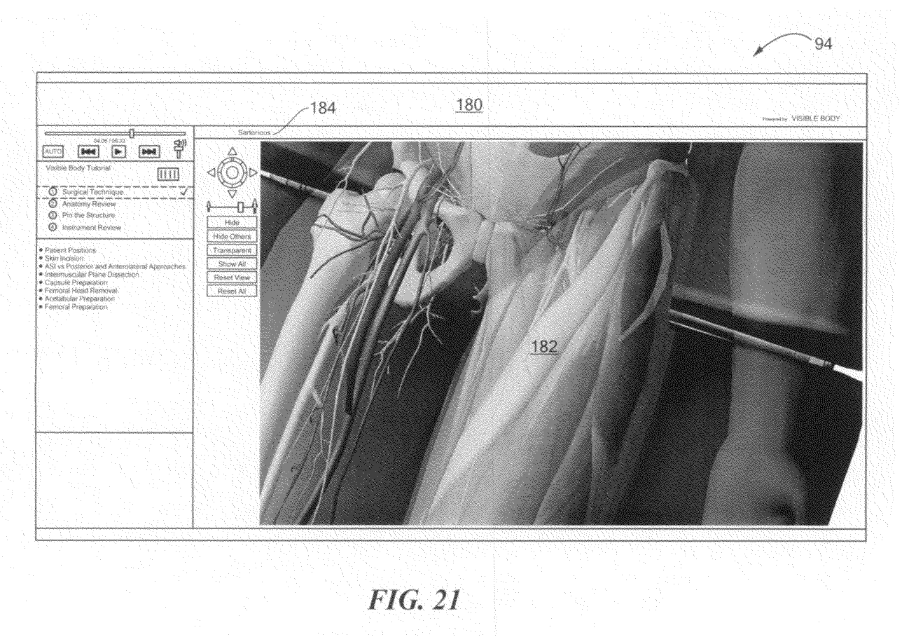

For example, view 180, FIG. 21, shows one example of real-time, interactive, 3D virtual surgical procedure 94 wherein a user desires to select and identify human anatomical structure 182. To do this, the user selects structure 182, e.g., by clicking, touching, or similar type command, and the name of structure 182, the sartorius is indicated at 184.

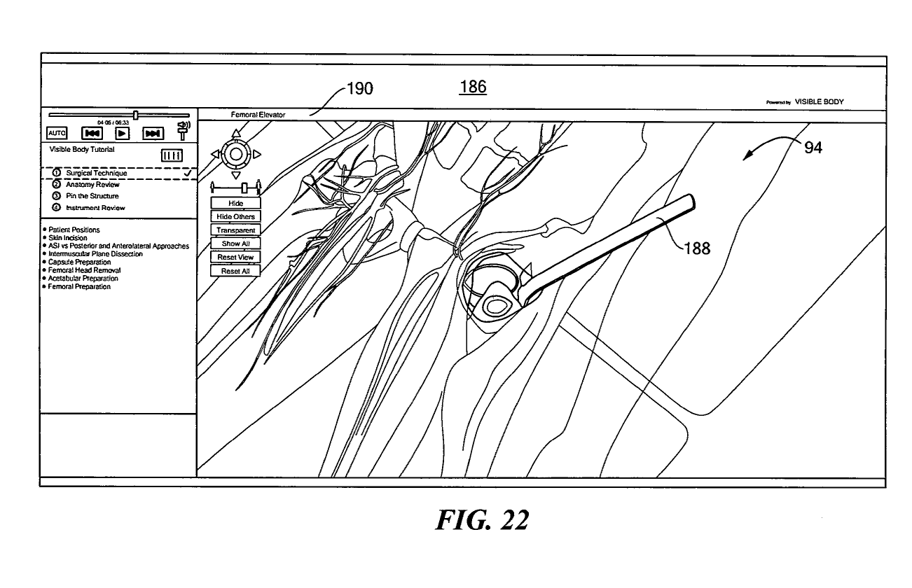

View 186, FIG. 22, shows one example of real-time, interactive, 3D virtual surgical procedure 94 wherein a user desires to select and identify medical instrument or surgical tool 188. In a similar manner as discussed above, the user selects tool 188 and the name of surgical tool 188, the “Femoral Elevator” is indicated at 190.

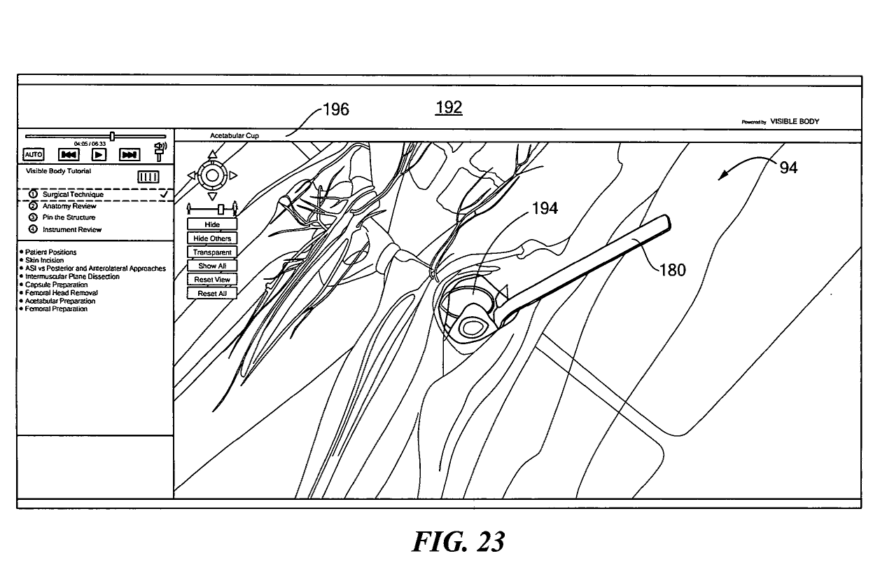

View 192, FIG. 23, shows one example of real-time, interactive, 3D virtual surgical procedure 94 wherein a user desires to select and identify medical device 194. In this example, the user selects medical device 194 and the name of medical device 194, the “acetabular cup” is indicated at 196.

The result is system 10 can select and identify any 3D representations of human anatomical structures, medical devices and medical instruments in real-time, interactive, 3D virtual surgical procedure 94 to provide more accurate training of surgical procedures to medical professionals.

Timeline controller 76, FIG. 1, may be configured to generate audio playback commands and send them to audio controller 200, as shown at 202. Audio controller 200 is responsive to the audio playback commands and inputs audio file 204. Audio file 204 preferably includes a voice-over surgical explanation of the real-time, interactive, 3D virtual surgical procedure 94. Audio controller 200 plays audio file 204 with real-time, interactive, 3D virtual surgical procedure 94, as shown at 208.

System 10, FIG. 1, may also be configured to provide on-screen text of real-time, interactive, 3D virtual surgical procedure 94 to further assist surgical in the training of surgeon. In this design, timeline controller 76 generates on-screen text display commands that are sent to on-screen text controller 240, as shown at 242. On-screen text controller 240 is configured to input text file 246, e.g., a text XML file, or similar type text file, as shown at 248. Text file 246 preferably includes a textual explanation of the virtual surgical procedure 94. On-screen controller 240 integrates the on-screen text in text file 246 with real-time, interactive, 3D virtual surgical procedure 94, as show at 250.

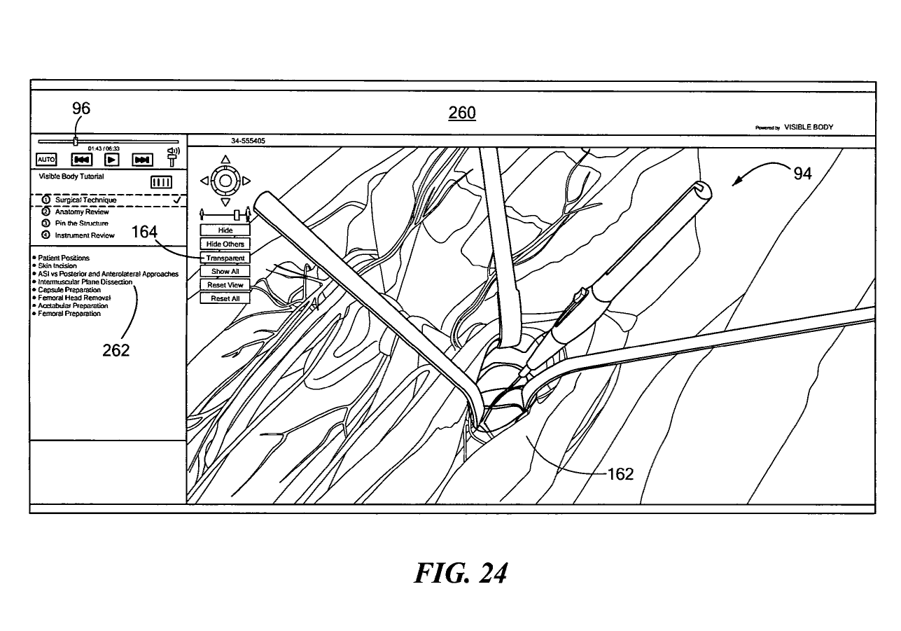

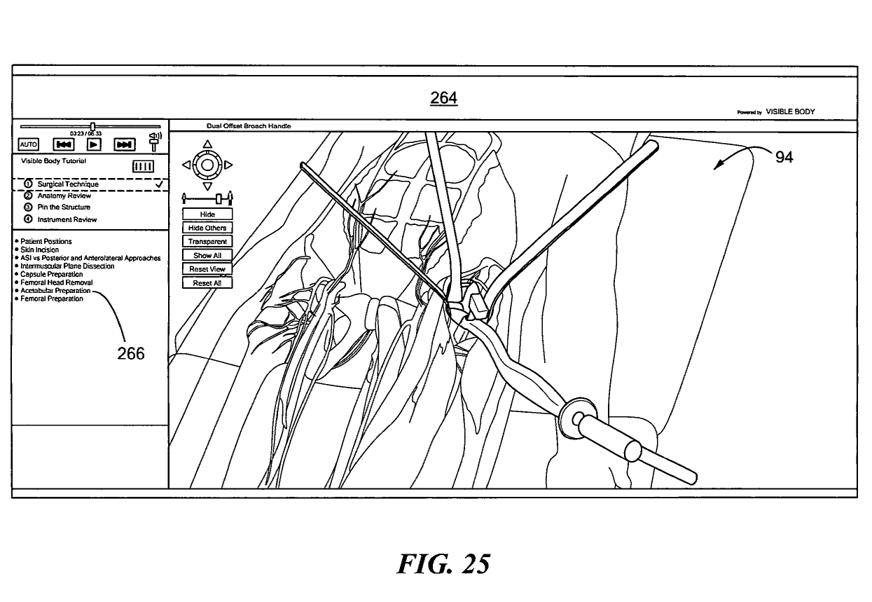

For example, view 260, FIG. 24 shows one example of textual explanation 262 of the current step of real-time, interactive, 3D virtual surgical procedure 94 at 01:43, namely, the “Intermuscular Plane Dissection” step. Similarly, view 264, FIG. 25, shows another example of textual explanation 266 of the current step of real-time, interactive, 3D virtual surgical procedure 94 at 08:23, namely, the “acetabular preparation”. Textual explanations are available at virtually any desired location in real-time, interactive, 3D virtual surgical procedure 94.

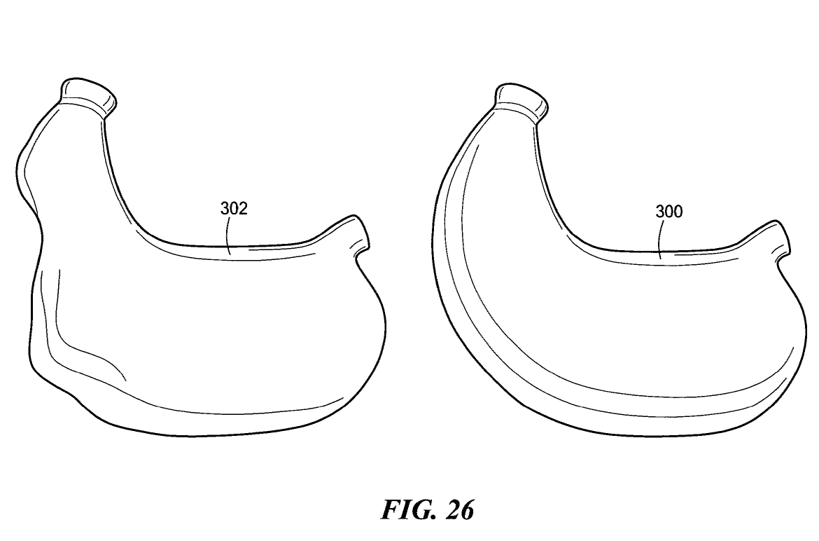

As discussed above with reference to FIGS. 13-24, the definable properties of the 3D objects, FIG. 1, in scene 12 may include the opacity level and the selection/identification of the 3D objects. The definable properties also preferably include the position in 3D space over time as shown in FIGS. 7-24. That is, real-time, interactive, 3D virtual surgical procedure 94 shows any of the human anatomical structures, medical instruments, or medical devices at different points in time to represent motion during the virtual surgical procure 94. The definable properties may also include the 3D shape of the objects. For example, FIG. 26 shows one example of object 300 of the stomach having one shape and object 302 of the stomach having a different shape.

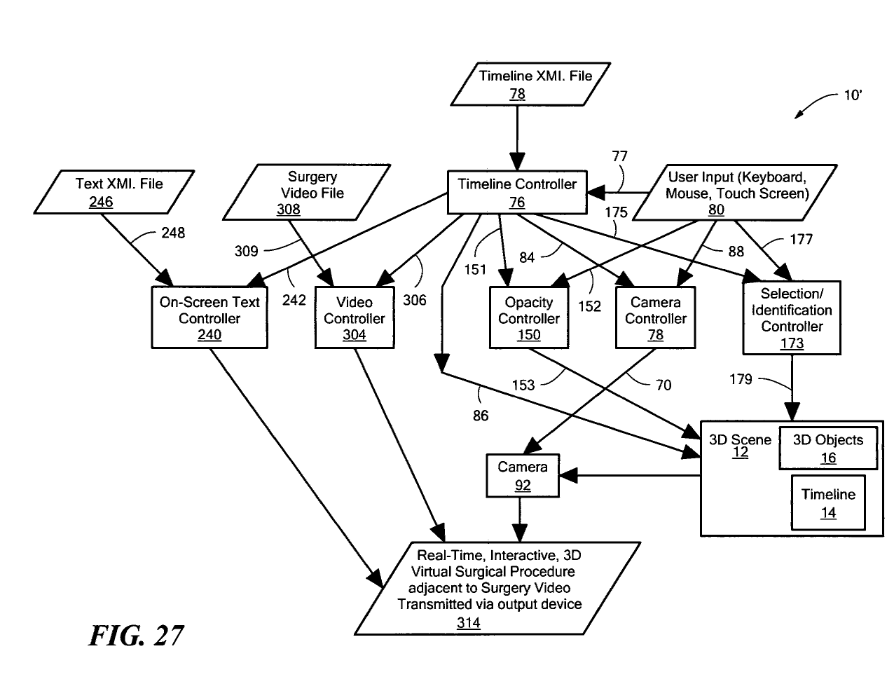

In another embodiment, timeline controller 76, FIG. 27, where like parts have like numbers, of system 10′ is configured to generate video playback commands and send the video playback commands to video controller 304, as shown at 306. Video controller 304 is responsive to the video playback commands, and is configured to input video file 308 as shown at 309 which includes a video of an actual surgical procedure. Video controller then displays the video of the actual surgical procedure adjacent to and synchronized with a real-time, interactive, 3D virtual surgical procedure, e.g. real-time, interactive, 3D virtual surgical procedure 94 discussed above with reference to one or more of FIGS. 1-26. Preferably the video of the actual surgical procedure includes audio associated the actual surgical procedure.

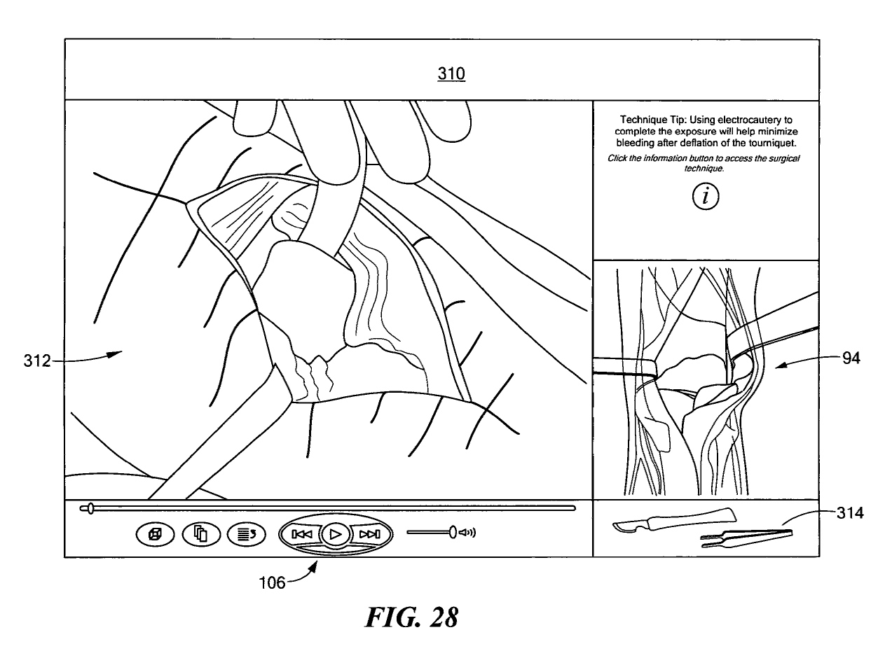

For example, view 310, FIG. 28, where like parts have like numbers, combines real surgical video 312 with real-time, interactive, 3D virtual surgical procedure 94. As discussed above, real surgical video 312 is synchronized with 3D virtual surgical procedure 94 and displayed adjacent to real-time, interactive, 3D virtual surgical procedure 94, e.g., as shown by split-screens in view 310. In one example, the user can toggle seamlessly between real surgical video 312 and real-time, interactive, 3D virtual surgical procedure 94. Similar as discussed above with reference to one or more of FIGS. 1-25, system 10′, FIG. 27-28, similarly includes timeline 106, FIG. 28 which provides the ability for the user to stop, start, pause, rewind, fast-forward the real surgical procedure and real-time, interactive, 3D virtual surgical procedure 94 from one control. System 10′, FIGS. 27-28 may also include next instrument window 314, FIG. 28, which shows the next instrument that will be used in the real-time, interactive, 3D virtual surgical procedure 94. System 10′ may also include information center 316, FIG. 28, which may include surgical tips and links to product brochures and clinical references.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A real-time, interactive, three-dimensional (3D) virtual surgical system comprising:
a 3D scene including:
a timeline, and
a plurality of artist-rendered 3D objects each representing a human anatomical structure and a plurality of 3D objects each representing a medical device or instrument, each object having a number of definable properties each associated with a location on the timeline;
a timeline controller configured to input a timeline file and/or user timeline input, the timeline controller configured to generate camera controller commands, generate and send time commands to select locations on the timeline, and generate and send play or pause commands to the 3D scene;
a camera controller responsive to the camera controller commands and/or user camera position input, the camera controller configured to generate camera position commands for any camera position; and
a camera responsive to the camera position commands configured to read the 3D scene and generate and send views to an output device to create a real-time, interactive, 3D virtual surgical procedure including views for any camera position.

2. The system of claim 1 in which the timeline controller is further configured to generate opacity level data.

3. The system of claim 2 further including an opacity controller responsive to the opacity level data and/or user opacity input, the opacity controller configured to generate and send opacity level commands to the 3D scene to define the opacity level of one or more of the 3D objects to create the real-time, 3D, virtual surgical procedure having one or more 3D objects with different opacity levels.

4. The system of claim 1 in which the timeline controller is further configured to generate selection/identification data.

5. The system of claim 4 further including a selection/identification controller responsive to the selection/identification data and/or user selection/identification input, the selection/identification controller configured to generate and send selection/identification commands to the 3D scene to define selection/identification of one or more of the 3D objects to create the real-time, 3D, virtual surgical procedure having selection and identification of one or more 3D objects.

6. The system of claim 1 in which the definable properties of each object associated with the timeline include one or more of: a 3D shape, a position in 3D space, an opacity level, and/or selection/identification status.

7. The system of claim 1 in which the timeline controller is further configured to generate audio playback commands.

8. The system of claim 7 further including an audio controller responsive to the audio playback commands configured to input an audio file including a voice-over surgical explanation of the virtual surgical procedure and integrate the audio file with the virtual surgical procedure.

9. The system of claim 1 in which the timeline controller is further configured to generate on-screen text display commands.

10. The system of claim 9 further including an on-screen text controller responsive to the on-screen text display commands configured to input a text file including on-screen text explaining the virtual surgical procedure and configured to integrate the on-screen text with the virtual surgical procedure.

11. The system of claim 1 in which the timeline controller is further configured to generate video playback commands.

12. The system of claim 11 further including a video controller responsive to the video playback commands configured to input a video file including a video of an actual surgical procedure and display the video adjacent to and synchronized with the real-time, interactive, three-dimensional virtual surgical procedure.

13. The system of claim 12 in which the video includes audio associated with the actual surgical procedure.

14. The system of claim 1 in which the output device includes an electronic display device.

15. The system of claim 14 in which the system is configured as an application to run on an electronic device accepting input and producing output.

16. A real-time, interactive, three-dimensional (3D) virtual surgical system comprising:
a 3D scene including:
a timeline, and
a plurality of artist-rendered 3D objects each representing a human anatomical structure and a plurality of 3D objects each representing a medical device or instrument, each object having a number of definable properties each associated with a location on the timeline;
a timeline controller configured to input a timeline file and/or user timeline input, the timeline controller configured to generate opacity level data, generate and send time commands to select locations on the timeline, and generate and send play or pause commands to the 3D scene;
an opacity controller responsive to the opacity level data and/or user opacity input, the opacity controller configured to generate opacity commands to define the opacity level of one or more of the 3D objects; and
a camera configured to read the 3D scene and generate and send views to an output device to create a real-time, interactive, 3D virtual surgical procedure having one or more 3D objects with different opacity levels.

17. The system of claim 16 in which the timeline controller is further configured to generate camera controller commands for any camera view and the camera is responsive to the camera position commands to create the real-time, interactive, 3D virtual surgical procedure having views for any camera position.

18. The system of claim 16 in which the timeline controller is further configured to generate selection/identification data.

19. The system of claim 18 further including a selection/identification controller responsive to the selection/identification data and/or user selection/identification input, the selection/identification controller configured to generate and send selection/identification commands to the 3D scene to define selection/identification of one or more of the 3D objects to create the real-time, interactive, 3D virtual surgical procedure having selection and identification of one or more of 3D objects.

20. The system of claim 16 in which the definable properties of each object associated with the timeline include one or more of: a 3D shape, a position and 3D space, and opacity level, and/or selection/identification status.

21. The system of claim 16 in which the timeline controller is further configured to generate audio playback commands.

22. The system of claim 21 further including an audio controller responsive to the audio playback commands configured to input an audio file including a voice-over surgical explanation of the virtual surgical procedure and integrate the audio file with the virtual surgical procedure.

23. The system of claim 16 in which the timeline controller is further configured to generate on-screen text display commands.

24. The system of claim 17 further including an on-screen text controller responsive to the on-screen text display commands configured to input a text file including on screen text explaining the virtual surgical procedure and configured to integrate the on-screen text with the virtual surgical procedure.

25. The system of claim 16 in which the timeline controller is further configured to generate video playback commands.

26. The system of claim 25 further including a video controller responsive to the video playback commands configured to input a video file including a video of an actual surgical procedure and display the video adjacent to and synchronized with the real-time, interactive, three-dimensional virtual surgical procedure.

27. The system of claim 26 in which the video includes audio associated with the actual surgical procedure.

28. The system of claim 16 in which the output device includes an electronic display device.

29. The system of claim 28 in which the system is configured as an application to run on an electronic device accepting input and producing output.

30. A real-time, interactive, three-dimensional (3D) virtual surgical system comprising:
a 3D scene including:
a timeline, and
a plurality of artist-rendered 3D objects each representing a human anatomical structure and a plurality of 3D objects each representing a medical device or a medical instrument, each object having a number of definable properties each associated with a location on the timeline;
a timeline controller configured to input a timeline file and/or user timeline input, the timeline controller configured to generate selection/identification data, generate and send time commands to select locations on the timeline, and generate and send play or pause commands to the 3D scene;
a selection/identification controller responsive to the selection/identification data and/or user selection/identification input, the selection/identification controller configured to generate and send selection/identification commands to the 3D scene to define selection/identification of one or more of the 3D objects; and
a camera configured to read the 3D scene and generate and send views to an output device to create a real-time, interactive, 3D virtual surgical procedure having selection and identification of one of more of 3D objects.

31. The system of claim 30 in which the timeline controller is further configured to generate camera controller commands for any camera view and the camera is responsive to the camera position commands to create the real-time, interactive, 3D virtual surgical procedure having views for any camera position.

32. The system of claim 30 in which the timeline controller is further configured to generate opacity level data.

33. The system of claim 32 further including an opacity controller responsive to the opacity level data and/or user opacity input, the opacity controller configured to generate and send opacity level commands to the 3D scene to define the opacity level of one or more of the 3D objects to create the real-time, 3D, virtual surgical procedure having one or more 3D objects with different opacity levels.

34. The system of claim 30 in which the definable properties of each object associated with the timeline include one or more of: a 3D shape, a position and 3D space, and opacity level, and/or selection/identification status.

35. The system of claim 30 in which the timeline controller is further configured to generate audio playback commands.

36. The system of claim 35 further including an audio controller responsive to the audio playback commands configured to input an audio file including a voice-over surgical explanation of the virtual surgical procedure and integrate the audio file with the virtual surgical procedure.

37. The system of claim 30 in which the timeline controller is further configured to generate on-screen text display commands.

38. The system of claim 31 further including an on-screen text controller responsive to the on-screen text display commands configured to input a text file including on screen text explaining the virtual surgical procedure and configured to integrate the on-screen text with the virtual surgical procedure.

39. The system of claim 30 in which the timeline controller is further configured to generate video playback commands.

40. The system of claim 39 further including a video controller responsive to the video playback commands configured to input a video file including a video of an actual surgical procedure and display the video adjacent to and synchronized with the real-time, interactive, three-dimensional virtual surgical procedure.

41. The system of claim 40 in which the video includes audio associated with the actual surgical procedure.

42. The system of claim 30 in which the output device includes an electronic display device.

43. The system of claim 42 in which the system is configured as an application to run on an electronic device accepting input and producing output.

44. A real-time, interactive, three-dimensional (3D) virtual surgical system comprising:
a 3D scene including:
a timeline, and
a plurality of artist-rendered 3D objects each representing a human anatomical structure and a plurality of 3D objects each representing and a plurality of 3D objects each representing a medical device or a medical instrument, each object having a number of definable properties each associated with a location on the timeline;
a timeline controller configured to input a timeline file and/or user timeline input, and/or user opacity input and/or user selection/identification input, the timeline controller configured to generate camera controller commands, generate opacity level data, generate selection/identification data, generate and send time commands to select locations on the timeline, and generate and send play or pause commands to the 3D scene;
an opacity controller responsive to the opacity level data and/or user opacity input, the opacity controller configured to generate opacity commands to define the opacity level of one or more of the 3D objects;
a selection/identification controller responsive to the selection/identification data and/or the user selection/identification input, the selection/identification controller configured to generate and send selection/identification commands to the 3D scene to define selection/identification of one or more of the 3D objects;
a camera controller responsive to the camera controller commands and/or user camera position input, the camera controller configured to generate camera position commands for any camera position; and
a camera responsive to the camera position commands configured to read the 3D scene and generate and send views to an output device to create a real-time, interactive, 3D virtual surgical procedure having views for any camera position, one or more 3D objects with different opacity levels, and selection and identification of one or more of 3D objects.

45. The system of claim 44 in which the timeline controller is further configured to generate video playback commands.

46. The system of claim 45 further including a video controller responsive to the video playback commands configured to input a video file including a video of an actual surgical procedure and display the video adjacent to and synchronized with the real-time, interactive, three-dimensional virtual surgical procedure.

47. The system of claim 46 in which the video includes audio associated with the actual surgical procedure.

48. A method for providing a real-time, interactive, three-dimensional (3D) virtual surgical system, the method comprising:
providing a 3D scene including a timeline and a plurality of artist-rendered 3D objects each representing a human anatomical structure and a plurality of 3D objects each representing a medical device or a medical instrument, each object having a number of definable properties each associated with a location on the timeline;
generating and sending timeline commands to select locations on the timeline;
generating and sending play or pause commands to the 3D scene;
generating camera positions for any camera position; and
generating and sending views to an output device to create a real-time, interactive, three-dimensional virtual surgical procedure having views for any camera position.

49. The method of claim 48 further including the step of generating opacity level commands and sending the opacity level commands to the 3D scene to define the opacity level of one or more of the 3D objects to create the real-time, 3D, virtual surgical procedure having one or more 3D objects with different opacity levels.

50. The method of claim 48 further including the step of generating selection/identification commands and sending the selection/identification commands to the 3D scene to define selection/identification of one or more of the 3D objects to create the real-time, 3D, virtual surgical procedure having selection and identification of one or more 3D objects.

51. The method of claim 48 further including the step of generating video playback commands.

52. The method of claim 51 further including the step of inputting a video file including a video of an actual surgical procedure and displaying the video adjacent to and synchronized with the real-time, interactive, three-dimensional virtual surgical procedure.

53. The method of claim 52 in which the video includes audio associated with the actual surgical procedure.

54. A method for providing a real-time, interactive, three-dimensional (3D) virtual surgical system, the method comprising:
generating a 3D scene including a timeline and a plurality of artist-rendered 3D objects each representing a human anatomical structure and a plurality of 3D objects each representing a medical device or a medical instrument, each object having a number of definable properties associated with a location on the timeline;
generating and sending timeline commands to select locations on the timeline;
generating and sending play or pause commands to the 3D scene;
generating opacity level commands to define the opacity levels of one or more of the 3D objects; and
generating and sending views to an output device to create a real-time, interactive, three-dimensional virtual surgical procedure having one or more 3D objects with different opacity levels.

55. The method of claim 54 further including the step of generating camera position commands for any camera position to create the real-time, 3D, virtual surgical procedure having views for any camera position.

56. The method of claim 54 further including the step of generating selection/identification commands and sending the selection/identification commands to the 3D scene to define selection/identification of one or more of the 3D objects to create the real-time, 3D, virtual surgical procedure having selection and identification of one or more 3D objects.

57. The method of claim 54 further including the step of generating video playback commands.

58. The method of claim 52 further including the step of inputting a video file including a video of an actual surgical procedure and displaying the video adjacent to and synchronized with the real-time, interactive, three-dimensional virtual surgical procedure.

59. The method of claim 58 in which the video includes audio associated with the actual surgical procedure.

60. A method for providing a real-time, interactive, three-dimensional (3D) virtual surgical system, the method comprising:
providing a 3D scene including a timeline and a plurality of artist-rendered 3D objects each representing a human anatomical structure and a plurality of 3D objects each representing medical device or medical instrument, each object having a number of definable properties each associated with a location on the timeline;
generating and sending timeline commands to select locations on the timeline;
generating and sending play or pause commands to the 3D scene;
generating selection/identification commands and sending the selection/identification commands to the 3D scene to define selection/identification of one or more of the 3D objects;
generating and sending views to an output device to create a real-time, interactive, three-dimensional virtual surgical procedure having selection and identification of one or more 3D objects.

61. The method of claim 60 further including the step of generating camera position commands for any camera position to create the real-time, 3D, virtual surgical procedure for any camera position.

62. The method of claim 60 further including the step of generating opacity level commands and sending the opacity level commands to the 3D scene to define the opacity level of one or more of the 3D objects to create the real-time, 3D, virtual surgical procedure having one or more 3D objects with different opacity levels.

63. The method of claim 60 further including the step of generating video playback commands.

64. The method of claim 63 further including the step of inputting a video file including a video of an actual surgical procedure and displaying the video adjacent to and synchronized with the real-time, interactive, three-dimensional virtual surgical procedure.

65. The method of claim 64 in which the video includes audio associated with the actual surgical procedure.

66. A method for providing a real-time, interactive, three-dimensional (3D) virtual surgical system, the method comprising:
providing a 3D scene including a timeline and a plurality of artist-rendered 3D objects each representing a human anatomical structure and a plurality of 3D objects each representing medical device or medical instrument, each object having a number of definable properties each associated with a location on the timeline;
generating and sending timeline commands to select locations on the timeline;
generating camera positions for any camera position;
generating opacity level commands to define the opacity levels of one or more of the 3D objects;
generating selection/identification commands and sending the selection/identification commands to the 3D scene to define selection/identification of one or more of the 3D objects;
generating and sending play or pause commands to the 3D scene; and
generating and sending views to an output device to create a real-time, interactive, three-dimensional virtual surgical procedure having views for any camera position, one or more 3D objects with different opacity levels, and selection and identification of one or more 3D objects.

67. The method of claim 66 further including the step of generating video playback commands.

68. The method of claim 67 further including the step of inputting a video file including a video of an actual surgical procedure and displaying the video adjacent to and synchronized with the real-time, interactive, three-dimensional virtual surgical procedure.

69. The method of claim 68 in which the video includes audio associated with the actual surgical procedure.
